(19) United States
(12) Patent Application Publication
(10) Pub. No.: US 2025/0257776 A1
(43) Pub. Date: Aug. 14, 2025

(54) SEAT AND TORSION DAMPER COMPRISING SAME

(71) Applicant: VALEO EMBRAYAGES, Amiens Cedex 2 (FR)

(72) Inventors: Fabrice CAVAIOTTI, Amiens (FR); Olivier BOUCHEZ, Amiens (FR); Xavier FESSELET, Amiens (FR)

(73) Assignee: VALEO EMBRAYAGES, Amiens Cedex 2 (FR)

(21) Appl. No.: 19/046,611

(22) Filed: Feb. 6, 2025

(30) Foreign Application Priority Data
Feb. 14, 2024 (FR) FR2401460

(51) Int. Cl. F16F 1/12; F16D 3/12

(52) U.S. Cl. CPC F16F 1/12; F16D 3/12; F16D 2300/12; F16D 2300/22; F16F 2230/0005

(57) ABSTRACT

A seat intended to be placed on one end of a first spring, notably of a torsion damping device for a vehicle. The seat includes a dorsal part having a body, which is designed to cooperate with the end of the first spring, and a bar portion forming a surface designed to be one element of a pivot connection. A frontal part of the seat is designed to be connected to the dorsal part by having complementing shapes.

The invention relates to seats for springs integrated in particular in torsion dampers for a transmission line of a vehicle. The invention also relates to torsion damping devices comprising such seats.

A torsion damping device integrated in a friction clutch is known. This device comprises a set of springs, the ends of which cooperate with the rest of the device via one-piece metal seats. More specifically, the torsion damping device has two coaxial parts mounted rotatably relative to one another counter to the aforementioned, circumferentially acting springs, with the one-piece metal seats acting between at least one of the spring ends, on one side, and one and/or the other of the coaxial parts, on the other side. To that end, each one-piece metal seat comprises a frontal part for abutting and/or centring the end of the spring or spring assembly with which it cooperates, and a dorsal part backing onto the frontal part and having a protruding bar portion that provides a pivot link with one and/or the other of the coaxial parts.

However, these one-piece seats are expensive to manufacture. Moreover, they have considerable mass, and this makes them complicated to use in respect of the overall requirements of reducing the mass of the friction clutch.

The present invention notably aims to further improve the seats of torque damping devices.

To that end, the invention provides a seat intended to be placed on one end of a first spring, notably of a torsion damping device for a vehicle, comprising:
a dorsal part comprising a body, which is designed to cooperate with the end of the first spring, and a bar portion forming a surface designed to be one element of a pivot connection; and
a frontal part designed to be connected to the dorsal part by having complementing shapes.

As a result, the seat according to the invention is in two parts, or is bipartite (i.e. the seat is not one-piece). These two parts of the seat offer a wide variety of shapes for reducing the mass of the seat and making it easier to manufacture while at the same time opposing the centrifugal movement of the first spring and allowing said first spring to work under good conditions, even at full torque, by keeping its ends parallel. The invention makes it possible to obtain cost-effective and lightweight seats without sacrificing their effectiveness.

Decreasing the mass of the seats has a direct impact on reducing the fuel consumption and on improving the recyclability of said seats. In addition, decreasing the mass of the seats also makes it possible to reduce the inertia of the torsion damping device.

The two distinct parts of the seat make it easier to design and manufacture each of said parts, it being possible for each of the components to have a dedicated manufacturing process. Moreover, the two parts can be assembled simply, i.e. by having complementing shapes, enabling rapid, simple and effective installation of the seat. In addition, manufacturing a seat in two parts makes it possible to make one of the parts, preferably the dorsal part, a standard part, making it possible to have a single reference irrespective of the products proposed and to only need to adapt the other of the parts, preferably the frontal part, to the specific dimensions of said products.

According to one of the aspects of the invention, the bar portion forms a cylindrical surface. This optimizes the pivot connection.

According to one of the aspects of the invention, the frontal part is independent of the dorsal part. Thus, the frontal part is not rigidly secured to the dorsal part, for example by adhesive bonding or welding, before being mounted. This freedom between the two parts of the seat makes it easier to mount or dismount the seat in the torsion damping device.

According to one of the aspects of the invention, the frontal part consists at least partially of a first material and the dorsal part consists at least partially of a second material, which is different from the first material. This makes it possible to choose the most suitable material for each of the parts of the seat by taking into account the constraints linked to their function while still looking to decrease the mass and the manufacturing costs of the seat.

According to one of the aspects of the invention, the frontal part of the seat is at least partially made of a synthetic material. This reduces the weight and the manufacturing cost of the seat without sacrificing its effectiveness.

According to another of the aspects of the invention, the frontal part of the seat is wholly made of a synthetic material. This further reduces the weight and the manufacturing cost of the seat without sacrificing its effectiveness.

According to one of the aspects of the invention, the dorsal part of the seat is at least partially made of metal. This maintains optimum effectiveness of the seat.

According to another of the aspects of the invention, the dorsal part of the seat is wholly made of metal. This maintains optimum effectiveness of the seat.

According to one of the aspects of the invention, the body of the dorsal part comprises at least one protuberance, which extends perpendicularly from an edge of said body and is designed to guide the first spring. As a result, the first spring abuts the body of the dorsal part and the at least one protuberance makes it possible to guide said first spring so that the latter does not move centrifugally. The at least one protuberance extends perpendicularly, or radially, in relation to the main surface of the body of the dorsal part.

According to one of the aspects of the invention, the body of the dorsal part comprises at least two protuberances, preferably four protuberances, situated opposite one another in pairs. As a result, the first spring is perfectly guided.

According to one of the aspects of the invention, the bar portion is tubular and has an open cross section facing the frontal part. This reduces the mass of the dorsal part without sacrificing its effectiveness.

According to one of the aspects of the invention, the frontal part comprises a body designed to provide at least one of the following: centring of the first spring, centring of a second spring internal to the first spring, and abutment of the second spring.

According to one of the aspects of the invention, the body of the frontal part is cross-shaped. This optimizes the shape of the body between its centring function and the minimization of its mass.

According to one of the aspects of the invention, the body of the frontal part comprises at least one first rib, which is secured to a first edge of said body, extends radially in relation thereto, and is designed to be inserted into a first slot formed on the body of the dorsal part. As a result, the dorsal part and the frontal part are nested one in the other by having complementing shapes. Furthermore, the first rib is designed to axially hold the seat in the event of angular travel with compression of the first spring.

According to one of the aspects of the invention, the body of the frontal part comprises two first ribs which extend facing one another.

According to one of the aspects of the invention, the body of the frontal part also comprises at least one second rib, which is secured to a second edge, situated opposite the first edge, of said body and extends radially in relation to said body, the second rib being designed to be inserted into a second slot formed on the body of the dorsal part. As a result, the dorsal part and the frontal part are nested one in the other by having complementing shapes. Furthermore, the second rib is designed to axially hold the seat in the event of angular travel with compression of the first spring.

According to one of the aspects of the invention, the body of the frontal part comprises two second ribs which extend facing one another.

According to one of the aspects of the invention, the first spring bears against the at least one first rib and against the at least one second rib. As a result, the first spring makes it possible to keep the dorsal part and the frontal part together.

The invention also relates to a torsion damping device, in particular for a vehicle, comprising two coaxial parts mounted rotatably relative to one another counter to at least one first spring with, positioned circumferentially between one of the ends of said first spring and one of the coaxial parts, a seat as described above, the dorsal part of the seat being designed to bear against said first spring and to itself bear against said coaxial part, and the frontal part of the seat being designed to be connected to the dorsal part by having complementing shapes.

Other features, details and advantages of the invention will become more clearly apparent from reading the following description, on the one hand, and from several exemplary embodiments given by way of non-limiting indication with reference to the appended schematic drawings, on the other hand, in which:

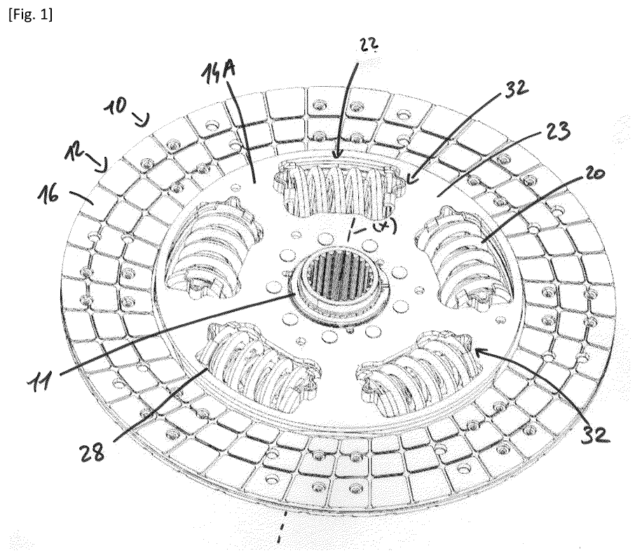

FIG. 1 is a front view, in semi-perspective, of a friction clutch comprising seats according to the invention;

FIG. 2 is a partial view of an enlargement of FIG. 1;

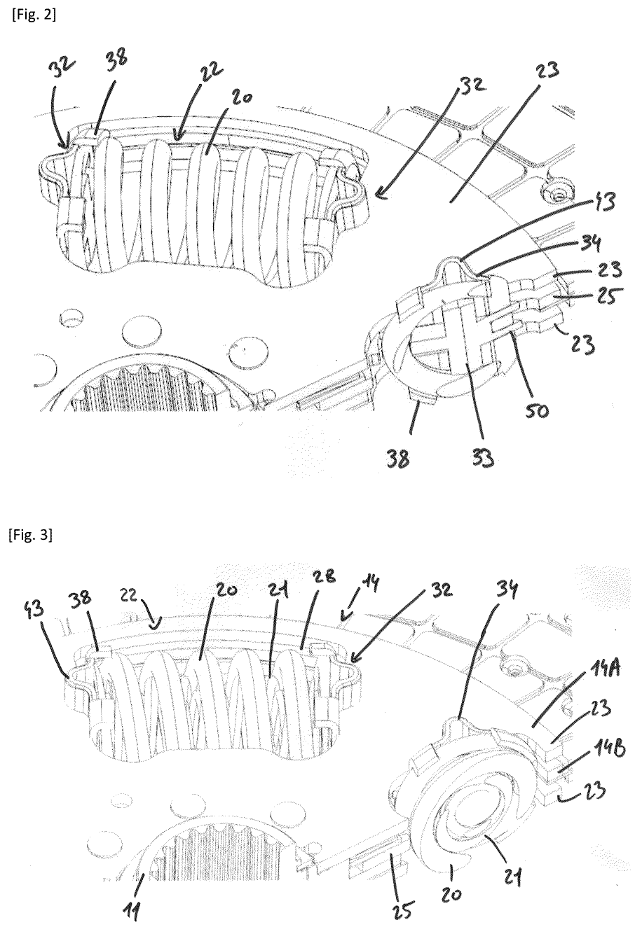

FIG. 3 is identical to FIG. 2, with an alternative embodiment of the seat according to the invention;

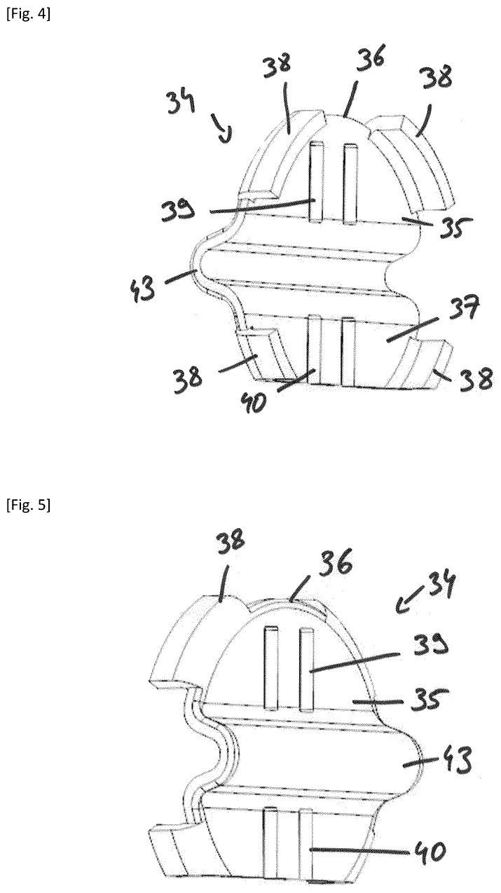

FIG. 4 is a front view, in perspective, of the dorsal part of the seat according to the invention;

FIG. 5 is a rear view, in perspective, of the dorsal part of FIG. 4;

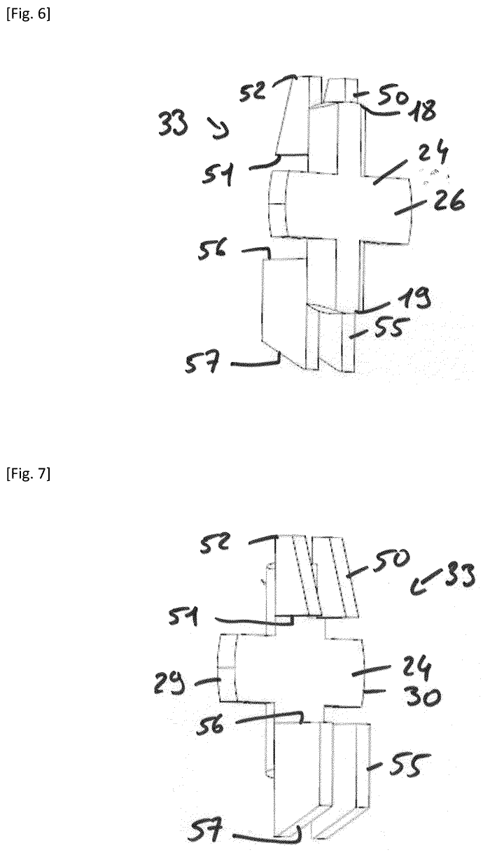

FIG. 6 is a front view, in perspective, of the frontal part of the seat according to the invention;

FIG. 7 is a rear view, in perspective, of the frontal part of FIG. 6;

FIG. 8 is a front view, in perspective, of the seat according to the invention;

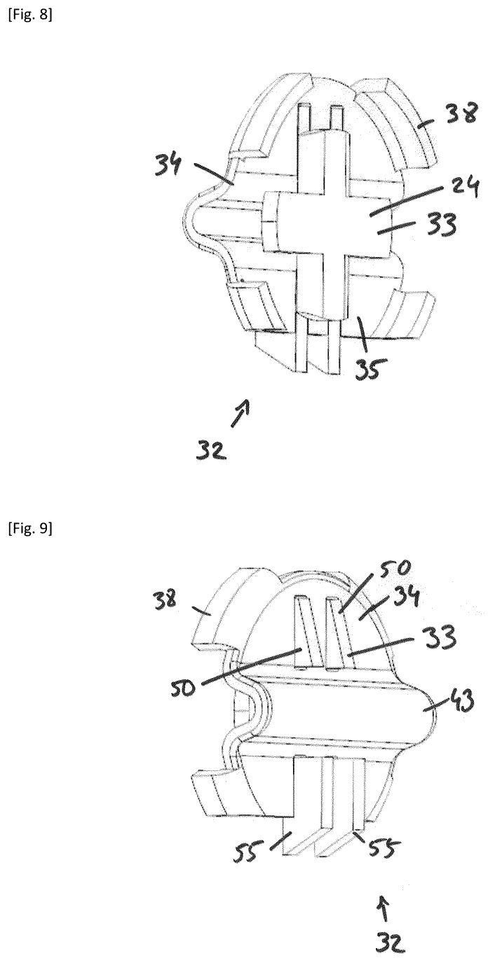

FIG. 9 is a rear view, in perspective, of the seat of FIG. 8;

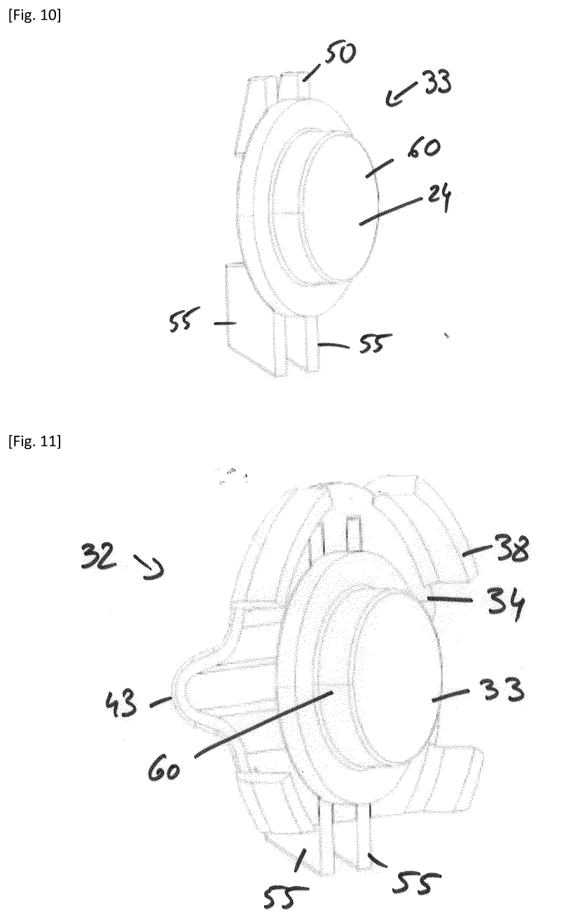

FIG. 10 is a front view, in perspective, of the frontal part of the seat according to the alternative embodiment of FIG. 3;

FIG. 11 is a front view, in perspective, of the seat comprising the frontal part of FIG. 10.

The features, variants and various embodiments of the invention may be combined with one another, in various combinations, as long as they are not mutually incompatible or mutually exclusive. It will be possible, in particular, to imagine variants of the invention that comprise only a selection of the features described below, in isolation from the other features described, if this selection of features is sufficient to confer a technical advantage and/or to distinguish the invention from the prior art.

In the description and the claims, the terms “outer” and “inner” and also the orientations “axial” and “radial” will be used, according to the definitions given in the description, to refer to elements of the torsion damping device. The axis of rotation X determines the “axial” orientation. The “radial” orientation is orthogonal to the axis of rotation X. The “circumferential” orientation is orthogonal to the axis of rotation X and orthogonal to the radial direction. Furthermore, the angles and angular sectors expressed are defined in relation to the axis of rotation X. The terms “outer” and “inner” are used to define the relative position of one component with respect to another, with reference to the axis of rotation X; a component close to said axis is thus described as inner as opposed to an outer component located radially at the periphery.

“Vehicle” is to be understood to mean motor vehicles, which comprise not only passenger vehicles but also industrial vehicles, this comprising in particular heavy goods vehicles, public transport vehicles or agricultural vehicles, but also any transport unit that makes it possible to move a living being and/or an object from one point to another, or any immobile unit that performs mechanical work.

Ordinal numeral adjectives are used to distinguish between features. They do not define the position of a feature. Consequently, for example, a third feature of a product does not mean that the product has a first and/or a second feature.

FIG. 1 shows, by way of example, the use of the invention for a friction clutch 10, in particular for a vehicle.

The friction clutch 10 may comprise a hub 11 and a friction disc 12, with a torsion damping device 14 acting in between.

The friction disc 12 may be designed to be wedged in rotation on a driving shaft, or crankshaft, connected to the engine of the vehicle. The hub 11 may be designed to be wedged in rotation on a driven shaft connected to the gearbox. The hub 11 may be rotatable about an axis of rotation X.

The friction disc 12 may comprise a web and, to provide clamping between the two plates of a clutch, which is not shown, two friction linings 16 each respectively attached to the periphery of the web, one on each side thereof. The web may be thin and possibly broken up into blades.

The torsion damping device 14 is designed to act at high torques. The torsion damping device 14 may comprise two coaxial parts 14A, 14B which, within the limits of a determined angular travel, are mounted rotatably relative to one another counter to damping devices 22 that act circumferentially between them. Each damping device 22 may comprise a single first spring 20. The first spring 20 may be a helical spring.

As an alternative, each damping device 22 may comprise a first spring 20 and a second spring 21, internal to the first spring 20. The first spring 20 is the external spring or the spring of larger diameter. The second spring 21 is the internal spring or the spring of smaller diameter. Thus, the outside diameter of the second spring is smaller than the inside diameter of the first spring 20. The first and the second spring are coaxial. The second spring 21 may be a helical spring. The second spring 21 may have a stiffness lower than the stiffness of the first spring 20. Each damping device 22 may also comprise a third spring located axially between the first and the second spring. The three springs are coaxial. The third spring may be a helical spring.

The coaxial part 14A may comprise two guide washers 23. The two guide washers 23 can be parallel to one another, preferably at a distance from one another. The two guide washers 23 may be connected, at their smallest-diameter periphery and with or without play, to the hub 11 in order to transfer the torque thereto.

The coaxial part 14B may comprise a web 25. The web 25 may act between the guide washers 23. The friction disc 12 may be fixed to the web 25.

It is possible to reverse the structure, with the web 25 meshing with play, for example via a toothing, with the hub 11 whereas the guide washers 23 are mounted rotationally freely in relation to the hub 11 by being connected to one another and secured to the friction disc 12, the latter being for example fixed by riveting to one of them.

The torsion damping device 14 may comprise a plurality of damping devices 22. In the example shown in FIG. 1, the torsion damping device 14 comprises five damping devices 22. The damping devices 22 may be evenly distributed circumferentially, by all being elongate substantially tangentially to a single circumference of the whole. The damping devices 22 may be each received in a receiving portion 28. The receiving portion 28 may be formed by a window provided on the guide washers 23 and by a window provided on the web 25.

Between at least one of the ends of the first spring 20 and one and/or the other of the coaxial parts 14A, 14B, a seat 32 may be circumferentially positioned. The seat 32 may comprise a frontal part 33 and a dorsal part 34.

The seat 32 may be bipartite. The frontal part 33 and the dorsal part 34 may be independent of one another. Before the seat is mounted in the torsion damping device 14, the frontal part 33 is not rigidly secured to the dorsal part 34. Each of the parts may be manufactured independently of the other of the parts and have its own manufacturing process, shape and/or material.

As an alternative, the seat 32 may be composed of a plurality of parts or units. For example, the frontal part 33 may be composed of a plurality of units. The dorsal part 34 may be composed of a plurality of units.

The frontal part 33 and the dorsal part 34 may be assembled by having complementing shapes. The dorsal part 34 may bear against the first spring 20. The dorsal part 34 may moreover abut one and/or the other of the coaxial parts 14A, 14B, by being mounted pivotably relative thereto about an axis parallel to their/its own axis and, thus, to the axis of rotation X of the hub 11. The frontal part may centre the first spring 20. As an alternative, the frontal part 33 may bear against and/or centre the second spring 21.

A seat 32 may be installed at each of the ends of the damping devices 22.

All the seats 32 may be identical.

The frontal part 33 may comprise a body 24. The body 24 may extend in the axial direction between a first end 29 and a second end 30. The body 24 may extend in the radial direction between a first edge 18 and a second edge 19. The body 24 may form a cross, with the first arm of the cross extending between the first end 29 and the second end 30 and the second arm of the cross extending between the first edge 18 and the second edge 19. Each of the edges and ends is designed to centre the first spring 20. Each of the edges and ends may additionally or alternatively abut the second spring 21. Each of the edges and ends may additionally or alternatively centre the second spring 21. The body 24 may have a flat first surface 26 facing the first spring 20. The body 24 may have a flat second surface opposite the first surface 26.

As an alternative, the body 24 may have a circular shape. The first surface 26 may comprise a stepped section 60 for the centring of the first spring 20. As an alternative or in addition, the stepped section 60 may enable the abutment and/or the centring of the second spring 21. The first surface 26 of the body 24 may comprise a single step 60. As an alternative, the first surface 26 of the body 24 may comprise, annularly and concentrically, two steps 60. The outermost step 60 centres the first spring 20, and the innermost step 60 abuts and centres the second spring 21.

Each of the steps 60 may comprise, perpendicularly in relation to the axis of the first spring 20 at rest, a transverse segment for the abutment of the first or second spring in question, and, parallel to that axis, an axial segment for centring that spring.

The frontal part 33 can also comprise at least one first rib 50. The first rib 50 may extend radially between an inner end 51 and an outer end 52. The first rib 50 may be secured to the body 24. More particularly, the first rib 50 may be secured to the first edge 18. The inner end 51 of the first rib 50 may be secured to the first edge 18 of the body 24. As an alternative, an intermediate segment, between the inner end 51 and the outer end 52, of the first rib may be secured to the first edge 18. The first rib 50 may be circumferentially offset from the body 24. The first rib 50 may extend circumferentially between a first end at least partially secured to the body 24 and a free second end. The first end of the first rib 50 may be flat. The first end of the first rib 50 may be parallel to the body 24. The free second end of the first rib 50 may be flat. The free second end of the first rib 50 may be tangential to the body 24.

With preference, the frontal part 33 may comprise a pair of first ribs 50 parallel to one another, preferably at a distance from one another.

The frontal part 33 can also comprise at least one second rib 55. The second rib 55 may extend radially between an inner end 56 and an outer end 57. The second rib 55 may be secured to the body 24. More particularly, the second rib 55 may be secured to the second edge 19. The inner end 56 of the second rib 55 may be secured to the second edge 19 of the body 24. As an alternative, an intermediate segment, between the inner end 56 and the outer end 57, of the second rib may be secured to the second edge 19. The second rib 55 may be circumferentially offset from the body 24. The second rib 55 may extend circumferentially between a first end at least partially secured to the body 24 and a free second end. The first end of the second rib 55 may be flat. The first end of the second rib 55 may be parallel to the body 24. The free second end of the second rib 55 may be flat. The free second end of the second rib 50 may be parallel to the body 24.

With preference, the frontal part 33 may comprise a pair of second ribs 55 parallel to one another, preferably at a distance from one another.

The first rib 50 and the second rib 55 may extend axially between the web 25 and the guide washers 23, their axial spacing depending on the thickness of the web 25. The function of the first rib 50 and the second rib 55 is to axially wedge the seats 32 on the web 25, to avoid them coming out of the receiving portions 28 of the damping device 22.

The frontal part 33 may be produced by a forging process. As an alternative, the frontal part 33 may be produced by a cold heading process.

The dorsal part 34 may comprise a body 35. The body 35 may be at least partially circular. The body 35 may be circular with a flat segment. The body 35 may have a continuous edge 36. The body 35 may have a flat first surface 37 facing the first spring 20. The surface 37 may be designed to serve as abutment for the first spring 20. The body 35 may have a flat second surface opposite the first surface 37. The second surface may be in contact with one and/or the other of the coaxial parts 14A, 14B.

The body 35 may also comprise a bar portion 43. The bar portion 43 may be a part of the body 35, more particularly a part of the second surface of the body 35. The bar portion 46 may be designed to bear against one and/or the other of the coaxial parts 14A, 14B. The bar portion 43 may protrude from the second surface of the body 35. The bar portion 43 may extend axially, i.e. parallel to the axis of rotation X of the hub 11. The bar portion 43 may, at least locally, have a cylindrical surface. The cylindrical surface may have a curved cross section.

The bar portion 43 may be formed by stamping on the body 35.

Via this dorsal part 34, the seat 32 may be rockingly engaged with a notch, of curved profile, on one of the radial edges of the windows of the guide washers 23 of the coaxial part 14A, and/or with a notch, of curved profile, on one of the radial edges of the windows of the web 25 of the coaxial part 14B. The profiles of the notches may complement the profile of the bar portion 43.

By way of this rocking, the seats 32 advantageously allow the ends of the damping devices 22 to remain substantially parallel to one another during use. At rest, they bear against the radially innermost part of the radial edges of the windows of the guide washers 23. At the end of the angular travel between them and the web 25, they bear against the radially outermost part of these radial edges.

The cylindrical surface of the bar portion 43 may have a circular cross section.

The bar portion 43 may be tubular. The cross section may be circularly closed. With preference, as shown in the figures, the cross section of the bar portion 43 may be open towards the frontal part 33, at an opening angle less than 180°.

The bar portion 43 may form an insert on which at least one part of the body 24 of the frontal part 33 can be inserted. The body 24 of the frontal part 33 may completely go into the inner volume of the bar portion 43. With preference, the body 24 of the frontal part 33 may partially go into the inner volume of the bar portion 43.

In a variant, the bar portion 43 may be solid.

If the bar portion 43 is solid, the material of the body 24 of the frontal part 33 coats it.

The first rib 50 and the second rib 55 of the frontal part 33 may be disposed, facing one another, on either side of the bar portion 43. The first rib 50 and/or the second rib 55 may extend over at least one segment of the bar portion 43, for example by closely following the shape thereof at least locally. The first rib 50 and the second rib 55 may make it possible to snap-fit the bar portion 43 to the frontal part 33. To this end, the first rib 50 and the second rib 55 may extend slightly at an angle, by converging towards one another on either side of the bar portion 43. In this embodiment, the frontal part 33 is not independent of the dorsal part 34.

As an alternative, the first rib 50 and the second rib 55 of the frontal part 33 may be at a distance from the bar portion 43. The first spring 20 may exert a pressure on the first rib 50 and the second rib 55 in order to keep the frontal part 33 with the dorsal part 34.

The dorsal part 34 can also comprise at least one protuberance 38. The protuberance 38 may extend circumferentially. The protuberance 38 may extend perpendicularly in relation to the body 35 between an integral first end of said body 35 and a free second end. The protuberance 38 is designed to guide the first spring 20. The protuberance 38 may have a curved shape. The shape of the protuberance 38 may be designed to closely follow the shape of the turns of the first spring 20.

With preference, the dorsal part 34 may comprise a pair of protuberances 38, preferably opposite one another in pairs. More particularly, the dorsal part 34 may comprise two pairs of protuberances 38, preferably opposite one another in pairs.

The dorsal part 34 can also comprise at least one first slot 39. More particularly, the body 35 of the dorsal part 34 may comprise at least one first slot 39. The first slot 39 may be a through-slot. The first slot 39 may be closed. The first slot 39 is designed to receive the first rib 50 by having complementing shapes.

With preference, the dorsal part 34 may comprise a pair of first slots 39 parallel to one another, preferably at a distance from one another.

The dorsal part 34 can also comprise at least one second slot 40. More particularly, the body 35 of the dorsal part 34 may comprise at least one second slot 40. The second slot 40 may be a through-slot. The second slot 40 may be open on at least one of its ends, preferably its inner end. The second slot 40 is designed to receive the second rib 55 by having complementing shapes.

With preference, the dorsal part 34 may comprise a pair of second slots 40 parallel to one another, preferably at a distance from one another.

According to the invention, the frontal part 33 of the seats 32 may be at least partially made of a first material. As an alternative, the frontal part 33 may be wholly made of this first material. The dorsal part 34 of the seats 32 may be at least partially made of a second material. As an alternative, the dorsal part 34 may be wholly made of this second material. The first material may be different from the second material. The first material may be a synthetic material, for example plastic or polyamide 6.6. The second material may be metal such as a steel with a high proportion of carbon or aluminium.

1. Seat intended to be placed on one end of a first spring, notably of a torsion damping device for a vehicle, comprising:
a dorsal part comprising a body, which is designed to cooperate with the end of the first spring, and a bar portion forming a surface designed to be one element of a pivot connection; and
a frontal part designed to be connected to the dorsal part by having complementing shapes.

2. Seat according to claim 1, wherein the frontal part is independent of the dorsal part.

3. Seat according to claim 1, wherein the frontal part consists at least partially of a first material and the dorsal part consists at least partially of a second material, which is different from the first material.

4. Seat according to claim 1, wherein the body of the dorsal part comprises at least one protuberance, which extends perpendicularly from an edge of said body and is designed to guide the first spring.

5. Seat according to claim 1, wherein the bar portion is tubular and has an open cross section facing the frontal part.

6. Seat according to claim 1, wherein the frontal part comprises a body designed to provide at least one of the following: centring of the first spring, centring of a second spring internal to the first spring, and abutment of the second spring.

7. Seat according to claim 6, wherein the body of the frontal part comprises at least one first rib, which is secured to a first edge of said body, extends radially in relation thereto, and is designed to be inserted into a first slot formed on the body of the dorsal part.

8. Seat according to claim 7, wherein the body of the frontal part additionally comprises at least one second rib, which is secured to a second edge, situated opposite the first edge, of said body and extends radially in relation to said body, the second rib being designed to be inserted into a second slot formed on the body of the dorsal part.

9. Seat according to claim 8, wherein the first spring bears against the at least one first rib (50) and against the at least one second rib.

10. Torsion damping device, in particular for a vehicle, comprising two coaxial parts mounted rotatably relative to one another counter to at least one first spring with, positioned circumferentially between one of the ends of said first spring and one of the coaxial parts, a seat according to claim 1, the dorsal part of the seat being designed to bear against said first spring and to itself bear against said coaxial part, and the frontal part of the seat being designed to be connected to the dorsal part by having complementing shapes.

11. Seat according to claim 2, wherein the frontal part consists at least partially of a first material and the dorsal part consists at least partially of a second material, which is different from the first material.

12. Seat according to claim 2, wherein the body of the dorsal part comprises at least one protuberance, which extends perpendicularly from an edge of said body and is designed to guide the first spring.

13. Seat according to claim 2, wherein the bar portion is tubular and has an open cross section facing the frontal part.

14. Seat according to claim 2, wherein the frontal part comprises a body designed to provide at least one of the following: centring of the first spring, centring of a second spring internal to the first spring, and abutment of the second spring.

15. Torsion damping device, in particular for a vehicle, comprising two coaxial parts mounted rotatably relative to one another counter to at least one first spring with, positioned circumferentially between one of the ends of said first spring and one of the coaxial parts, a seat according to claim 2, the dorsal part of the seat being designed to bear against said first spring and to itself bear against said coaxial part, and the frontal part of the seat being designed to be connected to the dorsal part by having complementing shapes.

16. Seat according to claim 3, wherein the body of the dorsal part comprises at least one protuberance, which extends perpendicularly from an edge of said body and is designed to guide the first spring.

17. Seat according to claim 3, wherein the bar portion is tubular and has an open cross section facing the frontal part.

18. Seat according to claim 3, wherein the frontal part comprises a body designed to provide at least one of the following: centring of the first spring, centring of a second spring internal to the first spring, and abutment of the second spring.

19. Torsion damping device, in particular for a vehicle, comprising two coaxial parts mounted rotatably relative to one another counter to at least one first spring with, positioned circumferentially between one of the ends of said first spring and one of the coaxial parts, a seat according to claim 3, the dorsal part of the seat being designed to bear against said first spring and to itself bear against said coaxial part, and the frontal part of the seat being designed to be connected to the dorsal part by having complementing shapes.

20. Seat according to claim 4, wherein the bar portion is tubular and has an open cross section facing the frontal part.
